(19) United States
(12) Patent Application Publication
(10) Pub. No.: US 2002/0032637 A1
(43) Pub. Date: Mar. 14, 2002

(54) Method and apparatus for graphical representation of real-time data

(76) Inventors: David Clive Moshal, San Francisco, CA (US); Eric Thich Vi Ly, Mountain View, CA (US); Michael Ames Lenz, Mountain View, CA (US); Lonnie Jackson Eldridge, San Mateo, CA (US); Judge Kennedy Arora, Los Gatos, CA (US)

Correspondence Address: WILSON SONSINI GOODRICH & ROSATI, 650 PAGE MILL ROAD, PALO ALTO, CA, 943041050

(21) Appl. No.: 09/782,932

(22) Filed: Feb. 13, 2001

Related U.S. Application Data
(60) Provisional application No. 60/183,677, filed on Feb. 18, 2000.

(51) Int. Cl. G06F 17/60

(52) U.S. Cl. 705/37

(57) ABSTRACT

A method for effecting and monitoring a real-time, multi-participant process via a network. In one embodiment, the method includes periodically collecting real-time data regarding the real-time process, and periodically updating a display comprising a graphical representation of a current state of the process using the real-time data. The method further includes receiving user inputs via the display, wherein the user inputs include changes to the real-time data, and in response to the user inputs, updating the display to reflect the changes to the real-time data.

### RELATED APPLICATIONS

This patent application claims priority from U.S. Provisional patent application Serial No. 60/183,677, entitled Method and Apparatus for Graphical Representation of Real-Time Data, filed Feb. 18, 2000.

### FIELD OF THE INVENTION

The invention is in the field of software for processing and representing real-time data.

### BACKGROUND OF THE DISCLOSURE

For many processes that involve constantly changing data, it is desirable for a user of the data to be able to have access to an understandable version of a current state of critical data. This is particularly true when the user must make a decision based upon real-time data that will not remain static for very long. Increasingly, interactive processes are conducted by multiple participants via some electronic network. Each participant may at any time take an action that changes the critical data of the process. An example of such a process is an auction that is conducted via the Internet. Participants are typically multiple buyers and sellers who may change ask prices and bid prices at any time.

Currently, auctions that are conducted in a networked environment, such as the Internet, are limited in the types of information provided to auction participants. An auction participant generally lists a product or service, or solicits a product or service, on an auction site. Participants then bid upon the product or service of interest. Generally, the listing of a product or service, either offered or solicited, is placed in a standard hypertext markup language (HTML) text listing at a particular auction web site. Auction participants may submit a bid or solicit offers, typically via electronic mail, for a particular product or service. In conventional electronic auctions, the auction participants do not have access to auction information other than the current asking price of the offered or solicited product or service. In conventional electronic auctions, participants are generally not aware of the dynamics of a current active auction, such as: data on other offers or bids from other auction participants; whether a particular auction transaction has been completed; how the auction participant's offers or bids compare with those of other auction participants; and a variety of other changing auction data.

The typical auction environment has another disadvantage, namely, general latency problems with updating and processing bids and offers. Commonly, in current auction systems, a series of different bids or offers sent via electronic mail are received by a particular auction system but are not expeditiously processed. As a result, some auction participants are excluded from effectively participating in particular auctions, or their participation is delayed. Current electronic auctions, therefore, do not provide participants with important data regarding current auction dynamics.

### SUMMARY OF THE DISCLOSURE

Embodiments of the present invention include an interactive user interface for effecting and monitoring real-time processes. In one embodiment the user interface includes software instructions that cause an operating system to periodically collect real-time data regarding a real-time process. The real-time data is used to update a display with a graphical representation of the current state of the process. Multiple objects on the display represent, for example, buyers and sellers. The objects on the display convey various pieces of changing information, such as: the number of items offered by a seller; the relative magnitude of a price offered by a buyer; how close a bid price and an ask price are; how long a bid or ask has been outstanding; when a bid or ask has been updated; and when a transaction is consummated. The information is instantaneously conveyed in a variety of ways, including: color of objects; relative positions of objects; and position of objects relative to a point on the display. In one embodiment, a server is periodically polled for real-time data with which to update the display. The update frequency can be controlled by a user. The type of data updated can also be controlled by a user. The user interface is also interactive; for example a process participant can change the real-time data by manipulating objects on the display.

### BRIEF DESCRIPTION OF THE DRAWINGS

FIG. 1 shows an embodiment of a user interface display.

FIG. 2 shows an embodiment of a user interface display.

FIG. 3 shows an embodiment of a user interface display.

FIG. 4 shows an embodiment of a user interface display.

FIG. 5 shows an embodiment of a user interface display.

FIG. 6 shows an embodiment of a user interface display.

FIG. 7 shows an embodiment of a user interface display.

FIG. 8 shows an embodiment of a user interface display.

FIG. 9 shows an embodiment of a user interface display.

FIG. 10 shows an embodiment of a user interface display.

FIG. 11 shows an embodiment of a user interface display.

FIG. 12 shows an embodiment of a user interface display.

FIG. 13 shows an embodiment of a user interface display.

FIG. 14 shows an embodiment of a user interface display.

FIG. 15 shows an embodiment of a user interface display.

FIG. 16 shows an embodiment of a user interface display.

FIG. 17 shows an embodiment of a user interface display operating as a banner on an Internet web page.

FIG. 18 shows an embodiment of a user interface display.

### DETAILED DESCRIPTION

An interactive user interface for effecting and monitoring real-time processes is described. The user interface includes software instructions that cause real-time data about the process to be collected and graphical information about the current state of the process to be displayed to a user or participant. The display can be part of a client computer on a network such as the Internet. The real-time data is changeable by a participant who manipulates the graphical display. Participating in the process is therefore much easier and faster than previously possible. The user interface provides an intuitive, interactive real-time environment for participants in any data-intensive process. In one embodiment, the user interface provides an intuitive, interactive real-time environment for participants in a network electronic auction.

In one embodiment, the user interface (“UI”) includes template-generated hypertext markup language (HTML) pages and dynamic content. The dynamic content could be in any form, such as Java and DHTML. One component of the UI is an interactive graphical representation (“display”) 100 of real-time data that is shown in FIG. 1. The display 100 typically appears on a display device of a user or participant. The display 100 conveys information and is also a control device in that it accepts participant input directly through manipulation of the objects on the display 100. A single seller or buyer is represented by the large object 102 in the center of the display 100, and individual buyers or sellers are represented by various buyer objects and seller objects around the object 102.

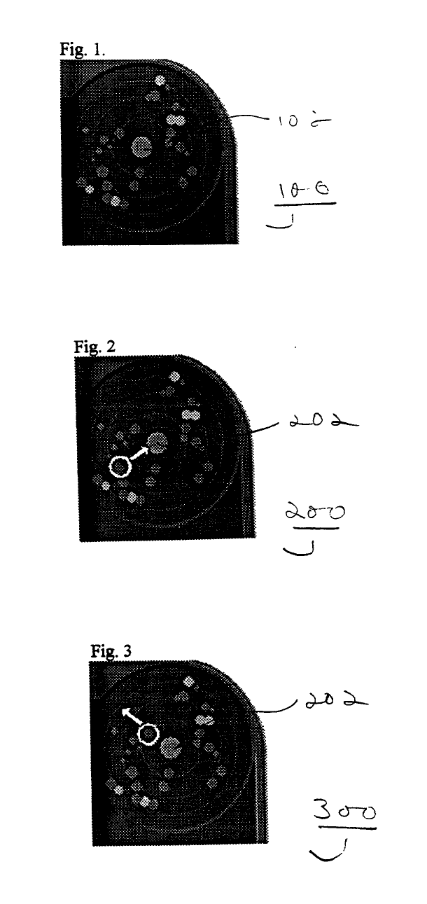

The display changes as the real-time auction data changes. For example, as shown in display 200 in FIG. 2, as the prices offered by the buyers (in one particular marketplace) more closely approach the asking price of the seller represented by seller object 202, the pertinent buyer objects move proportionally on the display 200. In display 300 of FIG. 3, as the prices offered by the buyers (in one particular marketplace) diverge from the asking price of the seller represented by seller object 202, the pertinent buyer objects move proportionally on the display 300. The display functions symmetrically with respect to buyers and sellers; that is, either a seller can be represented in the center, surrounded by many buyers, or a buyer can be depicted surrounded by many sellers. As will be further described below, the display is also used to represent many buyers and sellers at the same time. Additionally, any objects other than circles could be used to represent the buyers and sellers.

The user interface includes many features, some of which will be discussed with reference to further figures. FIG. 4 illustrates how the position of objects relative to each other represents the degree to which transactions are close to consummation. Object positions are updated dynamically, and the distance between objects decreases as a transaction comes closer to consummation. This gives participants a clear impression of movement in the market. No participant action is required to watch updated information. In display 400, the transaction represented by “A” is closer to consummation than the transaction represented by “B”. A transaction takes place when the distance between a buyer object and seller object becomes zero. On display 400, a buyer object would travel to the center and touch seller object 402 when a transaction between the two is consummated. The movement of the buyer objects and seller objects on the display 400 produces an “at-a-glance” knowledge of market changes and conditions.

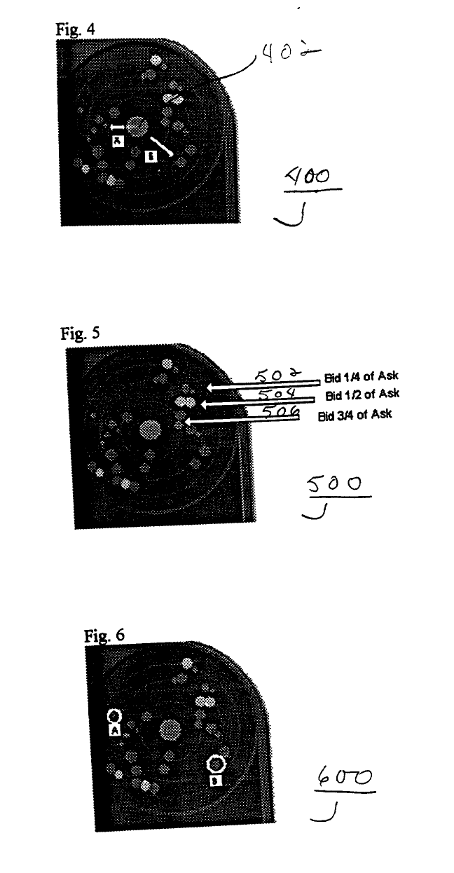

Distance as a representation of price or “score” produced by a multiparametric weighting can be represented on a logarithmic scale in one embodiment. This means that movements in the market are accelerated near the center. These accelerated movements produce an exaggerated representation of market conditions near the consummation of a transaction. In display 500 of FIG. 5, the grid lines 502, 504 and 506 are placed at ¼ of the asking price, ½ of the asking price, and ¾ of the asking price, respectively. The lines 502, 504 and 506 provide a yet more specific, immediate visual quantification of the progress of an offer. These grid lines could be given other value representations (e.g. ⅓, ½, 2/3) if desired. In addition, the grid lines do not necessarily represent a percentage of an asking price; the lines can also represent the degree to which a proposal by a central buyer is met, in the case where the central object is a buyer. In that case, the grid lines 502, 504 and 506 would represent “ask ¼ of bid,” “ask ½ of bid,” etc. In other embodiments, distance is measured using a linear or other scale in place of the logarithmic scale.

Another feature of the display, illustrated in the display 600 of FIG. 6, is that the size of an object represents the number of items held or desired by a seller or buyer. Object “B” represents an offer for a greater number of items, while object “A” represents an offer for a smaller number of items because object B is larger than object A.

Color is also used to convey information. As an example: asks are colored orange; bids are colored blue; objects representing particular buyers or sellers who are using the user interface are colored red; updated offers are flashed yellow; and when a deal is consummated objects representing the participants in the deal are briefly colored purple. The flashing of updated offers in yellow and consummated transactions in purple gives an immediate visual impression of activity in the market.

Sound is used to convey information as well. When a transaction is consummated, a sound is produced. When new offers are entered into the user interface, a different sound is generated.

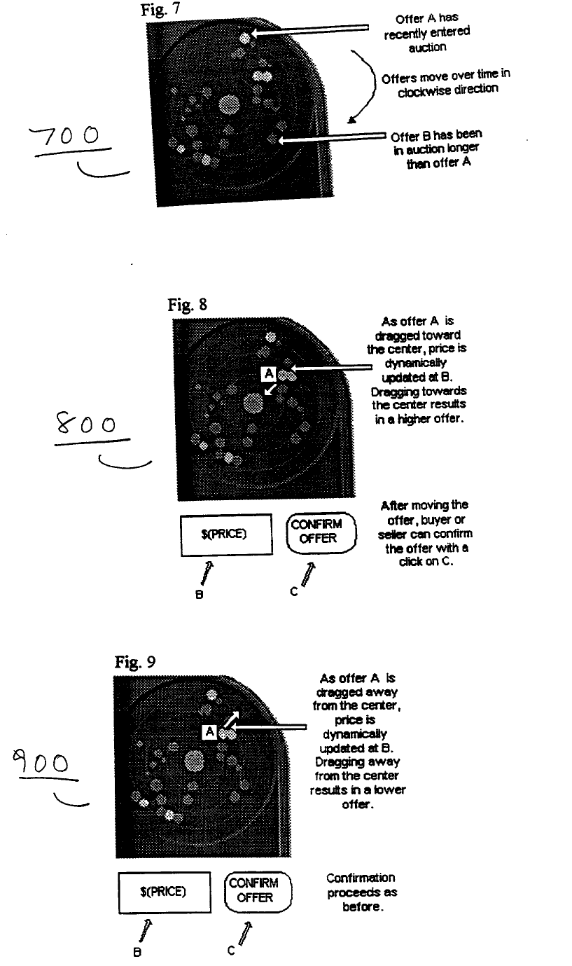

As shown in FIG. 7, the position of an offer on the display 700 as measured in radians or degrees from a reference point is used to convey information. The information conveyed includes the time a particular buyer or seller entered the auction. For example, offerors enter the auction at the 360° position on the display 700 and travel clockwise around the display as time progresses. Therefore, offer B has been in the auction for a longer period of time than offer A.

Embodiments of the user interface include an interactive display as shown in FIGS. 8 and 9. Buyers and sellers can manipulate their respective buyer objects and seller objects on the display to change the real-time auction data. In one embodiment, objects on the display are manipulated with an input device such as a mouse. For example, when a particular offer is selected and moved on the display, a corresponding price change (or “score” change, in a multi-criteria auction) is automatically entered for that offer. That is, the real-time data used by the system is changed to reflect the new price or score. This is a much easier and faster method of entering or changing an offer than conventional keyboard-based or template-based input systems.

The display 800 shows an offer being increased by dragging a corresponding object closer to the center of the display 800. The display 900 shows an offer being decreased by dragging a corresponding object away from the center of the display 900. In addition to the display, “price” button B and “confirm order” button C display the current offer price and allow the participant to confirm an order, respectively. As the object is dragged through the display field, the price at B is dynamically updated. The method described here (with a dynamically varying price display and a confirmation button) is one possible implementation of this system. For example, the confirmation button can be eliminated. After an offer is confirmed, the updated offer is sent to an auction engine.

Another feature of the user interface is that a user can learn more about an individual offer, such as quantity, price, and other information, with a “mouse over” using an arrow pointer or other similar technique.

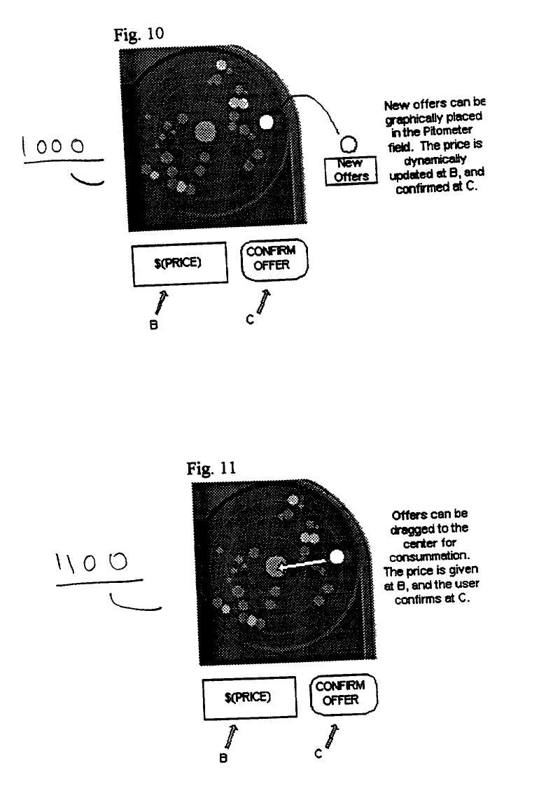

As illustrated in FIG. 10, offers can be graphically entered and placed in the display 1000 field. Offers can be removed from the display 1000 field in a similar fashion. The price is dynamically updated at B and the participant confirms at C.

As illustrated in FIG. 11, offers can be dragged to the center of the display 1100 for consummation. The price is dynamically updated at B and the participant confirms at C.

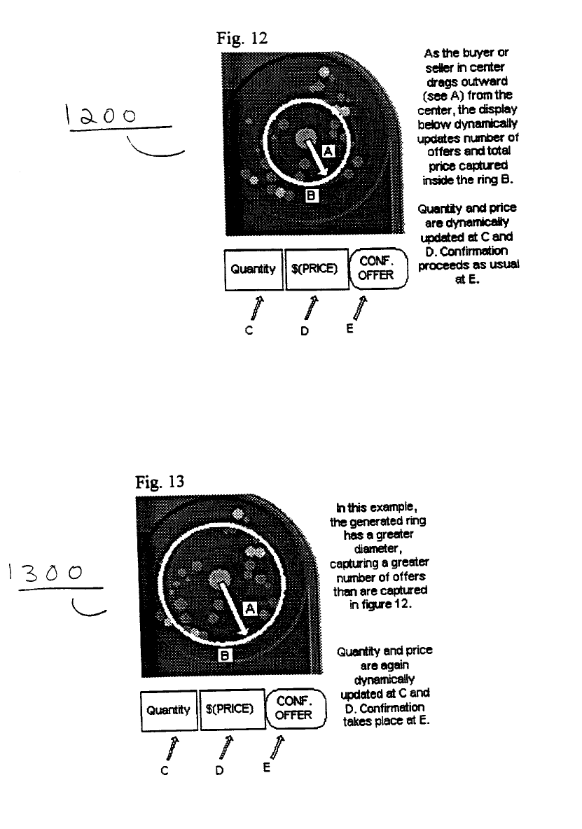

In one embodiment, a buyer or seller in the center can capture multiple offers at once through a “pull” feature. This is illustrated in FIGS. 12 and 13. For example, as a seller whose object is in the center of the display 1200 clicks in the center and drags outward from A to B, a dynamic calculation is made as to the number of offers inside the generated “ring” and how much money (in the case of offers defined by price) would be received by the seller if all the offers in the ring were accepted. Approximately nine offers have been captured inside the ring on the display 1200. The quantity and price are updated at C and D, and the participant can confirm at E. In FIG. 13, approximately twenty-four offers have been captured in display 1300. This interactive technique allows quick and intuitive cash and unit management for buyers and sellers. Offers inside the ring may represent different quantities, and this is included in the quantity and price calculations.

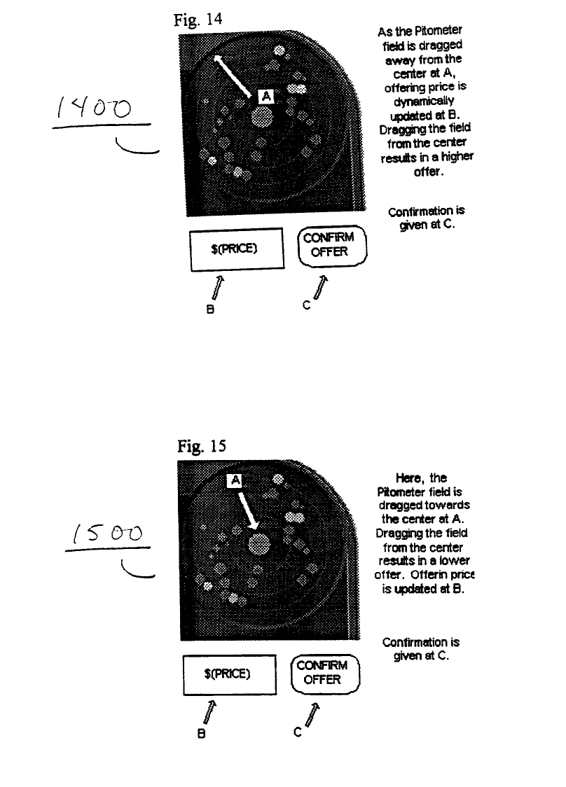

Referring to FIGS. 14 and 15, a buyer or seller whose object is in the center can dynamically vary his or her offering price by “grabbing” the display field and moving it closer or farther from the center. The display 1400 field is being dragged away from the center, resulting in a higher offer price. The display 1500 field is being dragged closer to the center, resulting in a lower offer price.

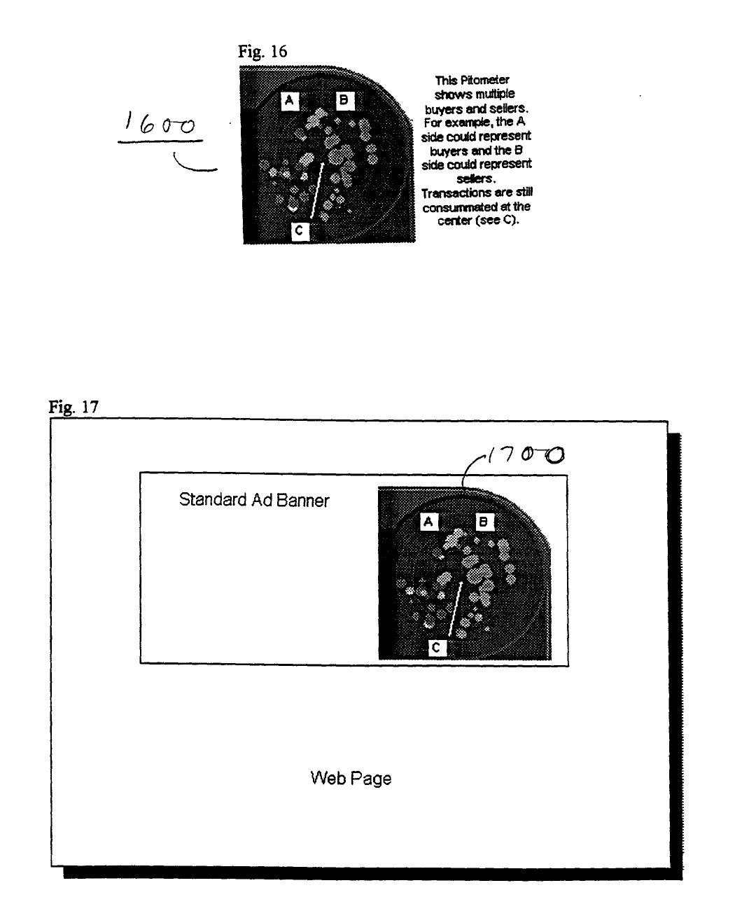

The user interface can be generalized to show many buyers and sellers at the same time, as shown in FIG. 16. Interactive features such as those previously described are implemented for a double display 1600. In one embodiment, the A side of the display 1600 represents buyers and the B side represents sellers. Transactions are consummated in the center C.

The user interface can be displayed over the Internet or any other network as a banner advertisement, which will give users the opportunity to see markets in a live fashion throughout the world wide web, as shown in FIG. 17. Users can also interact with the display 1700, through for example, DHTML and Java, or DHTML and JavaScript. Many other implementations are possible.

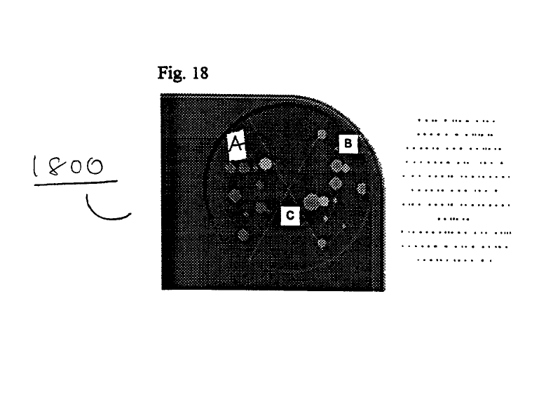

One embodiment of a user interface that includes multiple buyers and multiple sellers is shown in FIG. 18. The display 1800 has a “butterfly” design that separates the buyers and sellers. Two radial lines define an area occupied by either buyer objects or seller objects. In the display 1800, area A contains seller objects, and area B contains buyer objects. The remaining areas, as illustrated by C, are blank.

The manner in which the real-time data is collected and processed is variable. For example, in one embodiment, the user interface provides updates to web browsers in real time. To accomplish this, the display, as a Java applet in a browser, “polls back” to an originating server on a timed basis (e.g. once a second) to receive real-time data updates. These data updates allow the display to reflect the relative changes in offer positions. In some circumstances, this technique can result in a number and/or frequency of server requests that becomes burdensome to the server. Other embodiments help reduce the number of server requests while still providing pertinent real-time information graphically.

One of the alternate embodiments allows a participant to specify that the data associated with a subset of the objects displayed will be updated on a relatively more frequent basis, while the remainder are updated relatively less frequently. For example, suppose that there are M current offers (bids and asks) being displayed, and no differentiation is made as to data to be updated. In the previously described embodiment, each time an object is moved, the display polls back to the originating server with requests for M pieces of data to be displayed. In a first alternative embodiment, however, the user can specify that only N offers (where N is less than M) will be updated in real time, while the remaining M-N offers will receive updates on a less frequent basis. Generally, the N offers that are updated will be the highest bids and the lowest asks, or those most likely to result in a transaction at any particular time. As an actual example, if fifty offers are displayed, the user might specify that twenty of those offer be updated in real-time, or about once per second. The frequency with which the remaining thirty offers are updated can be specified as, for example, one fifth or less of the original frequency, that is, once every five seconds or less often. The frequency specified can be any frequency that is less than the original frequency. The frequency is typically chosen to optimize the reduction of server requests and the amount of data transferred per request.

A second alternative embodiment provides another way to reduce the number of requests to the server. In this embodiment, the display is initially set to refresh its data from the server at a specified frequency, for example once per second. The user interface then measures the rate of data change by determining an amount of change in a current set of data received and comparing it to the amount of change in a data set previously received. If the rate of data change is low, the user interface increases its refresh interval, for example from one second to two seconds. Conversely, if the rate of change is high, the user interface reduces its refresh interval. The user can set the upper and lower bounds for this procedure. Thus, a user might specify that the display will refresh no more often than once a second, but no less frequently than once every five minutes. In this way, an optimal refresh rate can be determined and the server is only heavily loaded when the rate of data change is high. In addition, the user experience is relatively unaffected, because the data refresh period is lengthened only when there are relatively few changes in the data to be observed.

The invention has been described with reference to specific examples. Various modification to the example embodiments may be made by one skilled in the art without departing from the scope of the invention, which is defined by the following claims.

1. A method for effecting and monitoring a real-time, multi-participant process via a network, the method comprising:
periodically collecting real-time data regarding the real-time process;
periodically updating a display comprising a graphical representation of a current state of the process using the real-time data;
receiving user inputs via the display, wherein the user inputs include changes to the real-time data; and
in response to the user inputs, updating the display to reflect the changes to the real-time data.

2. The method of claim 1, wherein periodically collecting real-time data comprises periodically polling a server coupled to the network browser to receive the real-time data.

3. The method of claim 1, wherein the real-time data includes current values of a plurality of variables, and wherein periodically collecting real-time data comprises:
receiving a user specification of a subset of the plurality of variables to be periodically collected at a first frequency; and
receiving a user specification of a second frequency at which the plurality of variables that does not include the subset is collected.

4. The method of claim 3, wherein the first frequency is approximately one collection per second, and the second frequency is a fraction of the first frequency.

5. The method of claim 4, wherein the real-time process comprises an Internet auction, wherein the plurality of variables includes offer amounts, and wherein the subset includes highest offer amounts.

6. The method of claim 1, wherein the real-time data includes current values of a plurality of variables, and wherein periodically collecting real-time data comprises:
initially collecting real-time data at a first frequency;
monitoring a rate of change of the real-time data collected at sequential periods;
changing a frequency at which real-time data is collected based upon the rate of change such that a relatively high rate of change results in the frequency being higher than the first frequency, and a relatively low rate of change results in the frequency being lower than the first frequency.

7. The method of claim 6, wherein periodically collecting real-time data further comprises receiving user-input upper and lower limits on the frequency.

8. The method of claim 2, wherein the display comprises template-generated hypertext markup language (HTML) pages, and wherein the real-time data is conveyed in Java.

9. The method of claim 2, wherein the real-time process comprises an Internet multi-participant auction, and wherein the real-time data comprises bid amounts and ask amounts.

10. The method of claim 9, wherein the display comprises a plurality of objects, each of which represent a participant in the auction, wherein a relative size of an object indicates a relative number of items held by a seller and a relative number of items desired by a buyer, and wherein the real-time data includes the relative number of items held by the seller and the relative number of items desired by the buyer.

11. The method of claim 10, wherein the plurality of objects comprise buyer objects and seller objects, wherein a relative distance of a buyer object from a seller object represents a relative closeness of an asking price associated with the seller object to an offer price associated with the buyer object, and wherein the real-time data includes the relative closeness of the asking price associated with the seller object to the offer price associated with the buyer object.

12. The method of claim 11, wherein the display is approximately circular, and wherein the display includes concentric grid lines that represent a degree to which a buyer proposal is met by a seller such that the location of objects relative to the concentric grid lines indicate a quantification of an offer's progress.

13. The method of claim 12, wherein the relative distance is produced by parametric weighting and displayed on a logarithmic scale such that changes in the auction are accelerated with proximity to the center of the circle.

14. The method of claim 11, wherein different colors are used on different objects to convey information about the objects, including:
whether an object is a seller object or a buyer object;
whether an object is associated with an ask or a bid;
whether an object represents a recently updated offer; and
whether a transaction is a consummated transaction.

15. The method of claim 11, wherein different sounds are used to convey information, including the consummation of a transaction, and an appearance of a new offer.

16. The method of claim 11, wherein the display is approximately circular, and wherein a radial position of an object on the display conveys information about the object, including a time at which a participant entered the auction and length of time the participant has been in the auction.

17. The method of claim 11, wherein the user is a participant, and wherein receiving user inputs includes the participant manipulating the display, wherein manipulating the display comprises the participant selecting and moving an object on the display, and wherein the server is sent updated information reflecting the user input.

18. The method of claim 11, further comprising a cursor that is manipulable on the display by the user, wherein the instructions, when executed, further cause the operating system to display information about an object when the cursor is moved over the object.

19. The method of claim 18, wherein the information includes quantity, price, length of time an offer has been available, an amount by which an offer changed since the offer first appeared on the display.

20. The method of claim 17, wherein manipulating the display further comprises the user placing an object representing an offer on the display and removing an object representing an offer from the display.

21. The method of claim 20, wherein manipulating the display further comprises the user moving an object representing an offer to a center of the display for consummation of a transaction.

22. The method of claim 21, wherein the display further comprises a graphical indication of an offer price that is separate from the display and a graphical offer to confirm the transaction that is separate from the display.

23. The method of claim 11, wherein the display is approximately circular, and wherein a participant displays information about multiple objects by manipulating a circle of varying circumference on the display such that information regarding objects that are inside the circle are displayed.

24. The method of claim 23, wherein the multiple objects comprise multiple offers, and wherein the information regarding objects that are inside the circle includes a number of offers inside the circle and a dollar amount representing all of the offers inside the circle.

25. An electromagnetic medium containing executable instructions which, when executed in an electronic network system component, cause the system component to:
periodically collect real-time data regarding the real-time process;
periodically update a display comprising a graphical representation of a current state of the process using the real-time data;
receive participant inputs via the display, wherein the participant inputs include changes to a the real-time data; and
in response to the participant inputs, update the display to reflect the changes to the real-time data.

26. The electromagnetic medium of claim 25, wherein the real-time process comprises a multi-participant process conducted over the network, and wherein periodically collecting real-time data comprises periodically polling the server from a network browser on one of the components to receive the real-time data.

27. The electromagnetic medium of claim 25, wherein the real-time process comprises a multi-participant process conducted over the network, wherein the real-time data includes current values of a plurality of variables, and wherein periodically collecting real-time data comprises:
receiving a participant specification of a subset of the plurality of variables to be periodically collected at a first frequency; and
receiving a participant specification of a second frequency at which the plurality of variables that does not include the subset is collected.

28. The electromagnetic medium of claim 27, wherein the first frequency is approximately one collection per second, and the second frequency is a fraction of the first frequency.

29. The electromagnetic medium of claim 28, wherein the real-time process comprises an Internet auction, wherein the plurality of variables includes offer amounts, and wherein the subset includes highest offer amounts.

30. The electromagnetic medium of claim 49, wherein the real-time process comprises a multi-participant process conducted over the network, wherein the real-time data includes current values of a plurality of variables, and wherein periodically collecting real-time data comprises:
initially collecting real-time data at a first frequency;
monitoring a rate of change of the real-time data collected at sequential periods;
changing a frequency at which real-time data is collected based upon the rate of change such that a relatively high rate of change results in the frequency being higher than the first frequency, and a relatively low rate of change results in the frequency being lower than the first frequency.

31. The electromagnetic medium of claim 30, wherein periodically collecting real-time data further comprises receiving participant-input upper and lower limits on the frequency.

32. The electromagnetic medium of claim 26, wherein the display comprises template-generated hypertext markup language (HTML) pages, and wherein the real-time data is conveyed in Java.

33. The electromagnetic medium of claim 26, wherein the real-time process comprises an Internet multi-participant auction, and wherein the real-time data comprises bid amounts and ask amounts.

34. The electromagnetic medium of claim 33, wherein the display comprises a plurality of objects, each of which represent a participant in the auction, wherein a relative size of an object indicates a relative number of items held by a seller and a relative number of items desired by a buyer, and wherein the real-time data includes the relative number of items held by the seller and the relative number of items desired by the buyer.

35. The electromagnetic medium of claim 34, wherein the plurality of objects comprise buyer objects and seller objects, wherein a relative distance of a buyer object from a seller object represents a relative closeness of an asking price associated with the seller object to an offer price associated with the buyer object, and wherein the real-time data includes the relative closeness of the asking price associated with the seller object to the offer price associated with the buyer object.

36. The electromagnetic medium of claim 35, wherein the display is approximately circular, and wherein the display includes concentric grid lines that represent a degree to which a buyer proposal is met by a seller such that the location of objects relative to the concentric grid lines indicate a quantification of an offer's progress.

37. The electromagnetic medium of claim 36, wherein the relative distance is produced by parametric weighting and displayed on a logarithmic scale such that changes in the auction are accelerated with proximity to the center of the circle.

38. The electromagnetic medium of claim 35, wherein different colors are used on different objects to convey information about the objects, including:
whether an object is a seller object or a buyer object;
whether an object is associated with an ask or a bid;
whether an object represents a recently updated offer; and
whether a transaction is a consummated transaction.

39. The electromagnetic medium of claim 35, wherein different sounds are used to convey information, including the consummation of a transaction, and an appearance of a new offer.

40. The electromagnetic medium of claim 35, wherein the display is approximately circular, and wherein a radial position of an object on the display conveys information about the object, including a time at which a participant entered the auction and length of time the participant has been in the auction.

41. The electromagnetic medium of claim 35, wherein receiving participant inputs includes the participant manipulating the display, wherein manipulating the display comprises the participant selecting and moving an object on the display, and wherein the server is sent updated information reflecting the participant input.

42. The electromagnetic medium of claim 35, further comprising a cursor that is manipulable on the display by the participant, wherein the instructions, when executed, further cause the operating system to display information about an object when the cursor is moved over the object.

43. The electromagnetic medium of claim 42, wherein the information includes quantity, price, length of time an offer has been available, and an amount by which an offer changed since the offer first appeared on the display.

44. The electromagnetic medium of claim 41, wherein manipulating the display further comprises the participant placing an object representing an offer on the display and removing an object representing an offer from the display.

45. The electromagnetic medium of claim 44, wherein manipulating the display further comprises the participant moving an object representing an offer to a center of the display for consummation of a transaction.

46. The electromagnetic medium of claim 45, wherein the display further comprises a graphical indication of an offer price that is separate from the display and a graphical offer to confirm the transaction that is separate from the display.

47. The electromagnetic medium of claim 35, wherein the display is approximately circular, and wherein a participant displays information about multiple objects by manipulating a circle of varying circumference on the display such that information regarding objects that are inside the circle are displayed.

48. The electromagnetic medium of claim 47, wherein the multiple objects comprise multiple offers, and wherein the information regarding objects that are inside the circle includes a number of offers inside the circle and a dollar amount representing all of the offers inside the circle.
